(19) United States
(12) Patent Application Publication
(10) Pub. No.: US 2024/0201328 A1
(43) Pub. Date: Jun. 20, 2024

(54) METHOD FOR DETECTING DEFOCUSING OF A LIDAR SENSOR AND LIDAR SENSOR

(71) Applicant: Robert Bosch GmbH, Stuttgart (DE)

(72) Inventors: Juan Carlos Garza Fernandez, Stuttgart (DE); Patrick Volz, Stuttgart (DE)

(21) Appl. No.: 18/541,743

(22) Filed: Dec. 15, 2023

(30) Foreign Application Priority Data
Dec. 20, 2022 (DE) 10 2022 214 042.7

(51) Int. Cl. G01S 7/48; G01S 17/08; G01S 17/931

(52) U.S. Cl. CPC G01S 7/4808; G01S 17/08; G01S 17/931; G01S 2007/4977

(57) ABSTRACT

A method for detecting defocusing of a LiDAR sensor. The method includes: emitting primary light as a laser line into a field of view of the LiDAR sensor to scan the field of view; receiving secondary light reflected and/or scattered in the field of view by an object using a matrix-shaped detector unit, the detector unit including a first receiving area and a second receiving area which differs from the first receiving area; determining a distance between the LiDAR sensor and an object based on secondary light received in the first receiving area; and ascertaining information about an extent of defocusing based on secondary light received in the second receiving area. The first receiving area is determined by calibrating the matrix-shaped detector unit. The first receiving area and the second receiving area are activated separately from one another to receive secondary light.

### CROSS REFERENCE

The present application claims the benefit under 35 U.S.C. § 119 of German Patent Application No. DE 10 2022 214 042.7 filed on Dec. 20, 2022, which is expressly incorporated herein by reference in its entirety.

### FIELD

The present invention relates to a method for detecting defocusing of a LiDAR sensor and a LiDAR sensor.

### BACKGROUND INFORMATION

In particular for use in driver assistance functions in the automotive sector, LiDAR (Light Detection and Ranging) sensors are often disposed in a housing with a transparent protective glass for protection against external environmental influences. The information transfer associated with the LiDAR sensor (e.g. the propagation of electromagnetic radiation/light) takes place through the protective glass. If this protective glass is contaminated by dirt, such as water or small particles, the flow of information is disrupted and the LiDAR sensor is restricted in terms of function. Certain weather phenomena, such as fog, rain, or snow, can interfere with the flow of information as well. To eliminate such a restriction of function, cleaning devices can be disposed on the outer side of the protective glass, for example,.

German Patent Application No. DE 10 2020 209 849 A1 describes a method for ascertaining an optical crosstalk of a LiDAR sensor, in particular a spatially resolving LiDAR sensor and such a LiDAR sensor.

German Patent Application No. DE 2018 217 467 A1 describes an optical system, in particular a LiDAR system, comprising a contamination recognition system.

### SUMMARY

The present invention relates to methods for detecting defocusing of a LiDAR sensor. According to an example embodiment of the present invention, the method(s) includes the following steps: emitting primary light in the form of a laser line into a field of view of the LiDAR sensor by means of at least one laser emitter unit of a transmitting unit of the LiDAR sensor to scan the field of view, receiving secondary light reflected and/or scattered in the field of view by an object by means of a matrix-shaped detector unit of a receiving unit, wherein the detector unit comprises a first receiving area and a second receiving area which differs from the first receiving area, determining a distance between the LiDAR sensor and an object in the field of view of the LiDAR sensor on the basis of secondary light received in the first receiving area by means of an evaluation unit and ascertaining information about an extent of defocusing on the basis of secondary light received in the second receiving area by means of an evaluation unit.

According to an example embodiment of the present invention, the first receiving area is determined by calibrating the matrix-shaped detector unit. The first receiving area and the second receiving area are activated separately from one another to receive secondary light. And the second receiving area is activated during individual scans of a plurality of consecutive scans. The first receiving area is configured from a first sequence of pixels along a plurality of rows of the matrix-shaped detector unit, wherein the first sequence comprises exactly one pixel in each row, and the second receiving area is configured from a pattern of pixels along the plurality of rows of the matrix-shaped detector unit, wherein the pattern comprises exactly one pixel in each row, and wherein the number of pixels of the pattern disposed outside the first receiving area is greater than the number of pixels of the pattern that overlap the first sequence.

A distance between a LiDAR sensor and an object in a field of view of the LiDAR sensor can be determined by means of the LiDAR sensor, for example based on a signal propagation time (time of flight TOF) or based on a frequency modulated continuous wave (FMCW) signal. For this purpose, the LiDAR sensor in particular comprises an evaluation unit which is configured to determine a light propagation time of the emitted primary light and the again received secondary light. This is in particular the same evaluation unit that ascertains the information about an extent of defocusing of the LiDAR sensor. Light propagation time methods include pulse methods, which determine the time of reception of a reflected laser pulse, or phase methods, which emit an amplitude-modulated light signal and determine the phase offset to the received light signal.

The LiDAR sensor according to the present invention in particular also comprises a deflection unit, by means of which primary light can be emitted into the field of view at different deflection angles. This makes it possible to scan the field of view. The respective angle-dependent individual measurements can be used to obtain an image of the surroundings. The deflection unit can, for instance, be configured as a rotating platform on which the transmitting unit and the receiving unit (or parts thereof) are disposed. The LiDAR sensor can therefore be configured as a rotating system, for example.

The LiDAR sensor can be configured for a vehicle or for a work device, for instance.

Defocusing of the LiDAR sensor can be caused by soiling on a protective glass of the LiDAR sensor, for example. Weather phenomena such as fog, rain or snow can alternatively or simultaneously likewise cause defocusing of the LiDAR sensor. Defocusing in particular causes a point spread function of the signals of the secondary light received on the detector unit to become wider than in a focused state of the LiDAR sensor.

According to an example embodiment of the present invention, the laser emitter unit can be configured to emit primary light in the form of a laser line. Alternatively, the laser emitter unit can emit primary light in the form of a punctiform laser beam and the transmitting unit can comprise optical units, for example optical lenses, that shape the punctiform laser beam into a laser line. The receiving unit can also comprise optical units, such as optical lenses, mirrors, etc.

The receiving unit can further comprise optical units, such as optical lenses, mirrors and the like. These can be configured to image the secondary light on the detector unit with as little loss as possible.

According to an example embodiment of the present invention, the first receiving area is in particular known prior to a distance measurement by means of the LiDAR sensor. Calibration in particular takes place chronologically before determining the distance between the LiDAR sensor and an object in the field of view, and also chronologically before ascertaining information about an extent of defocusing of the LiDAR sensor. Calibration can be carried out before the LiDAR sensor is put into operation, for instance. This makes it possible to ensure that a protective glass of the LiDAR sensor is not dirty, for instance.

In the calibration step, in particular exactly one pixel in which an intensity maximum of the received secondary light occurs is ascertained in each row of the matrix-shaped detector unit. The first receiving area is then configured from these pixels. The pixels ascertained by means of the calibration can also be referred to as activated pixels. In other words, the first receiving area is in particular configured from the pixels for which it was ascertained during the calibration step that an intensity maximum of the received secondary light occurs in this respective pixel of a row of the matrix-shaped detector unit. The first receiving area in particular comprises so-called activated pixels. Here, activated means that these pixels are used for a distance measurement by means of the LiDAR sensor.

The second receiving area in particular comprises so-called deactivated pixels. Here, deactivated means that these pixels are not used for a distance measurement by means of the LiDAR sensor.

The second receiving area being activated during individual scans of a plurality of consecutive scans can be understood to mean that, in the method presented here, pixels of the first receiving area are in particular activated during a majority of the scans. Pixels of the second receiving area are activated only with a certain number of scans. In other words, the LiDAR sensor most often uses multiple scans to determine a distance between the LIDAR sensor and an object in the field of view. Every few scans, however, the first receiving area is not activated and the second receiving area is activated instead. Purely as an example, this can happen every ten scans. However, the interval between scans in which the second receiving area is activated can also be smaller or larger. The second receiving area is in particular activated at a regular interval of scans. For instance, the interval can depend on a driving situation of a vehicle in which the LiDAR sensor is installed. If the vehicle is traveling at high speed, a longer interval may be appropriate to ensure the availability of the LIDAR sensor. At a lower speed, the second receiving area can also be activated more frequently. The interval can also be adjusted, for instance; for example if a point cloud recorded by the LiDAR sensor is only outputting points <100 m, because this could indicate soiling.

The number of pixels of the pattern disposed outside the first receiving area being greater than the number of pixels of the pattern that overlap the first sequence can be understood to mean that the pattern mostly comprises pixels that lie in columns of the matrix-shaped detector unit on a first side adjacent to the first sequence and pixels that lie in columns of the matrix-shaped detector unit on a second side adjacent to the first sequence.

The pattern partially overlapping the first sequence can in particular be understood to mean that a first portion of pixels of the pattern is identical to a portion of the pixels of the first sequence. This first portion of the pattern comprises fewer pixels than a second portion, the pixels of which are disposed outside the first receiving area. The feature can alternatively also be understood to mean that the pattern comprises pixels that lie in columns of the matrix-shaped detector unit on a first side adjacent to the first sequence and pixels that lie in columns of the matrix-shaped detector unit on a second side adjacent to the first sequence, in which case pixels of the first receiving area are left out.

An advantage of the present invention is that there is no need for an additional system for detecting defocusing. The matrix-shaped detector unit belonging to the LiDAR sensor can instead be used. Two directly successive scans of secondary light acquired by the detector unit, in which first the first receiving area and then the second receiving area were activated, can advantageously be compared with one another. If the first receiving area is angled on the detector unit, for example, defocusing can in particular already be detected within one scan by comparing adjacent rows with one another. If there is defocusing, this leads to a wider point spread function. Higher intensities of the signals can be detected in the second receiving area.

In an advantageous embodiment of the present invention it is provided that the first sequence is further configured such that a pixel of a row lies in a same column as a pixel of a directly adjacent row of the matrix-shaped detector unit and/or that a pixel of a row lies in a directly adjacent column like a pixel of a directly adjacent row of the matrix-shaped detector unit.

The first sequence is in particular configured from pixels which lie in a plurality of directly adjacent rows of a column. The first sequence can accordingly be configured as a straight line.

The first sequence is alternatively in particular configured such that a first portion of the pixels lies in a plurality of directly adjacent rows of a first column, and at least a second portion of the pixels lies in a plurality of directly adjacent rows of a second or further column which is directly adjacent to the first column or the column of the previous portion of the pixels. The first sequence can accordingly be configured as a stepped row. In particular at the stepped transitions, pixels are disposed, of which a portion of the pixels of the first sequence lie in the same column and a portion of the pixels lie in a directly adjacent column.

An advantage of this embodiment of the present invention is that the extent and the position of the first receiving area are particularly precisely adapted to the calibration. The first receiving area can be configured as a stepped row even if secondary light received as a line is not imaged exactly onto a column of the matrix-shaped detector unit. This makes it possible to define the first receiving area very precisely, regardless of whether the secondary light is imaged exactly onto a column or hits the matrix-shaped detector unit at a slight angle.

In a further advantageous embodiment of the present invention, it is provided that the method comprises the further step of transmitting the ascertained information about an extent of defocusing to a control unit of a vehicle, which is configured to control a driving function of the vehicle.

An advantage of this embodiment of the present invention is that using the LiDAR sensor in a vehicle can ensure the safety of a driving operation. For example, if the control unit of the vehicle receives information that the extent of defocusing of a particular LiDAR is so great that a distance measurement by means of the LiDAR can no longer be trusted, the control unit can actuate further steps within the vehicle. It can actuate the use of other LiDAR sensors installed in the vehicle for distance measurement, for instance. Or it can trigger the use of alternative sensors to ascertain the information needed for specific driving functions. It can also control means of the vehicle to vary a speed of the vehicle. The influencing of other driving functions by means of the control unit is possible.

In a further advantageous embodiment of the present invention, it is provided that the method comprises the further step of actuating a cleaning device of the LiDAR sensor when the extent of defocusing exceeds a specified threshold value.

An advantage of this embodiment of the present invention is that, if the detected defocusing is caused by soiling, said soiling can be removed. This can advantageously take place directly after soiling on the protective glass has been detected. It is particularly advantageous if the cleaning device cleans the protective glass while the LIDAR sensor is in operation or the operation of the LiDAR sensor only has to be interrupted for a short time. This makes it possible to avoid or at least significantly shorten failures of a LiDAR sensor, in particular in at least partially autonomously driving vehicles.

The present invention further relates to a computer program, which is configured to carry out the described method(s) of the present invention.

The present invention also relates to a machine-readable storage medium on which the described computer program according to the present invention is stored.

The present invention moreover relates to a LiDAR sensor comprising a transmitting unit having at least one laser emitter unit which is configured to emit primary light in the form of a laser line of light into a field of view of the LiDAR sensor, a receiving unit comprising a matrix-shaped detector unit which is configured to receive secondary light reflected and/or scattered in the field of view by an object, wherein the detector unit comprises a first receiving area and a second receiving area which differs from the first receiving area, and an evaluation unit which is configured to determine a distance between the LiDAR sensor and an object in the field of view of the LiDAR sensor on the basis of secondary light received in the first receiving area and to ascertain information about an extent of defocusing on the basis of secondary light received in the second receiving area.

According to an example embodiment of the present invention, the first receiving area can be determined by calibrating the matrix-shaped detector unit, and the first receiving area and the second receiving area can be activated separately from one another to receive secondary light, and the second receiving area can be activated during individual scans of a plurality of consecutive scans, and the first receiving area is configured from a first sequence of pixels along a plurality of rows of the matrix-shaped detector unit, wherein the first sequence comprises exactly one pixel in each row, and the second receiving area is configured from a pattern of pixels along the plurality of rows of the matrix-shaped detector unit, wherein the pattern comprises exactly one pixel in each row, and wherein the pattern partially overlaps the first sequence, and wherein the number of pixels of the pattern disposed outside the first receiving area is greater than the number of pixels of the pattern that overlap the first sequence.

In an advantageous embodiment of the present invention it is provided that the LiDAR sensor further comprises a cleaning device for preventing, inhibiting and/or removing at least one fleck of dirt on the protective glass.

In a further advantageous embodiment of the present invention, it is provided that the LiDAR sensor further comprises a control unit which is configured to control the cleaning device depending on detected soiling.

It goes without saying that the aforementioned features and the features yet to be explained in the following can be used not only in the respectively specified combination, but also in other combinations or on their own, without leaving the scope of the present invention.

### BRIEF DESCRIPTION OF THE DRAWINGS

Embodiment examples of the present invention are explained in more detail in the following with reference to the figures. Identical reference signs in the figures denote identical or functionally identical features.

FIG. 1 shows a schematic overview of components of a LiDAR sensor according to an example embodiment of the present invention.

FIG. 2 shows an example illustration of secondary light received on the detector unit without defocusing of the LiDAR sensor.

FIG. 3 shows an example illustration of secondary light received on the detector unit with defocusing of the LiDAR sensor.

FIG. 4 shows an embodiment example of a method for detecting defocusing of a LiDAR sensor, according to the present invention.

FIG. 5 shows an example illustration of the first and the second receiving area of the detector unit.

### DETAILED DESCRIPTION OF EXAMPLE EMBODIMENTS

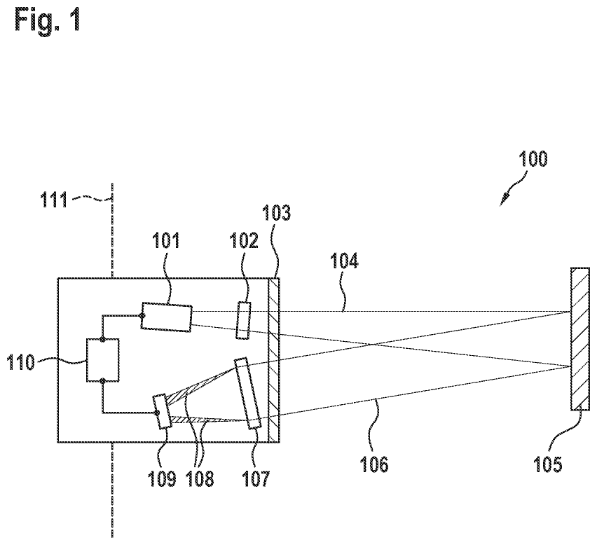

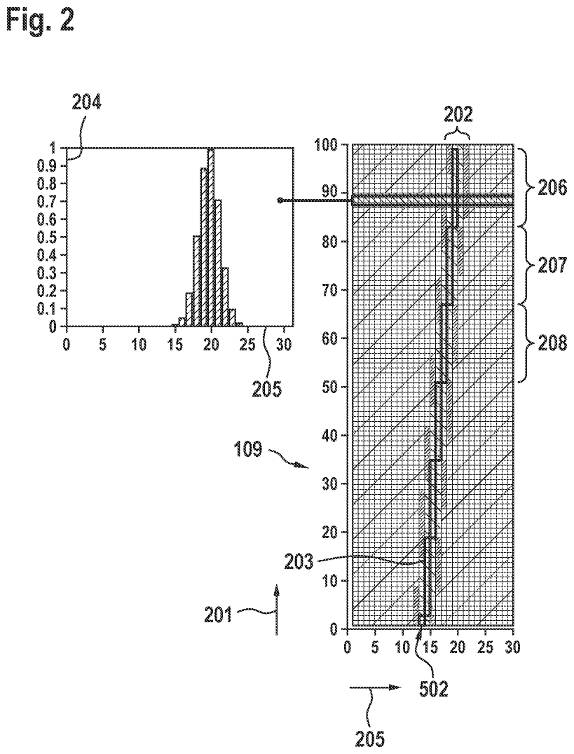

FIG. 1 shows an example of a schematic overview of components of a LiDAR sensor 100 according to the present invention. The LiDAR sensor 100 comprises a transmitting unit having a laser emitter unit 101 which in conjunction with transmitting optics 102 is configured to emit primary light 104 in the form of a laser line through a protective glass 103 of the LiDAR sensor 100 into a field of view of the LiDAR sensor 100. Secondary light 106 reflected and/or scattered in the field of view of the LiDAR sensor 100 by an object 105 reenters the LiDAR sensor 100 through the protective glass 103 of the LiDAR sensor 100 and is imaged onto a matrix-shaped detector unit 109 of the receiving unit by receiving optics 107 of a receiving unit of the LiDAR sensor 100. The detector unit 109 comprises a first receiving area and a second receiving area which differs from the first receiving area. The first receiving area can be determined by calibrating the matrix-shaped detector unit. The first receiving area and the second receiving area can be activated separately from one another to receive secondary light. The second receiving area can also be activated during individual scans of a plurality of consecutive scans. One possible configuration of the detector unit 109, including the first and the second receiving area, is described in more detail in FIGS. 2, 3 and 5. Due to a scattering property of the protective glass 103, for example as a result of soiling, the received secondary light can comprise scattered light components 108 that can reduce the accuracy of a spatial resolution of the LiDAR sensor 100. An evaluation unit 110 according to the present invention, which can be configured as an ASIC, for example, can be connected in terms of information technology to the laser emitter unit 101 and the matrix-shaped detector unit 109. Based on a computer program, which is executed by the evaluation unit 110 and implements the above-described method steps according to the present invention, the evaluation unit 110 is configured to determine a distance between the LiDAR sensor 100 and an object 105 in the field of view of the LiDAR sensor 100 on the basis of secondary light received in the first receiving area 203 and to ascertain information about an extent of defocusing. of the LiDAR sensor. The evaluation unit 110 can furthermore also be configured to carry out at least partial compensation of a change in a signal intensity of a portion of the secondary light received in the first receiving area.

The LiDAR sensor 100 can be configured as a rotating system which rotates about an axis of rotation 111, for example.

As an example, FIG. 2 shows an illustration of secondary light received on the detector unit 109 without (or with only very slight) defocusing of a LiDAR sensor 100 as shown as an example in FIG. 1. This is the case, for example, when the protective glass 103 has no soiling or only a very low small amount of scattering soiling. There are also currently no weather phenomena such as fog, rain or snow in the field of view of the LiDAR sensor.

The detector unit 109 comprises pixels which, in the example shown here, are arranged as a matrix with 100 rows 201 and 30 columns 205. The pixels on which secondary light is imaged are lighter, which corresponds to a signal intensity in the respective pixel. The secondary light is imaged on the detector unit 109 at a slight angle in the form of a line. In each row 201, the secondary light is imaged on pixels of approximately six columns. This is marked as an example for the 84^{th} to the 100^{th} row 201 with the bracket 202.

The first receiving area 203 used for the method according to the present invention for determining a distance between the LiDAR sensor 100 and an object 105 in the field of view of the LiDAR sensor 100 is determined by calibrating the matrix-shaped detector unit 109. Accordingly, in the example shown here, the first receiving area 203 is configured from a first sequence 502 of pixels along a plurality of rows 201 of the matrix-shaped detector unit 109, wherein the first sequence 502 comprises exactly one pixel in each row 201. The pixels that belong to the receiving area 203 are outlined in bolder print.

It can be seen that the first sequence 502 in the shown example is configured such that a pixel of a row 201 lies in a same column 205 as a pixel of a directly adjacent row 201 of the matrix-shaped detector unit 109 and/or that a pixel of a row 201 lies in a directly adjacent column 205 like a pixel of a directly adjacent row 201 of the matrix-shaped detector unit 109. The first sequence 502 is configured here as a stepped row. A first portion of the pixels of the sequence 502 lies in a plurality of directly adjacent rows 201 of a first column 205. Such a first portion is marked as an example with the bracket 206. A second portion of the pixels lies in a plurality of directly adjacent rows 201 of a second column 205, which is directly adjacent to the first column of the first portion 206 of the pixels. Such a second portion is marked as an example with the bracket 207. A further portion of the pixels lies in a plurality of directly adjacent rows 201 of a further column 205, which is directly adjacent to the second column of the second portion 207 of the pixels. Such a further portion is marked as an example with the bracket 208. All of the portions, also those not marked here, together form the stepped row.

To determine the first receiving area 203 by means of a calibration, in particular exactly one pixel in which an intensity maximum of the received secondary light occurs is ascertained in each row 201 of the matrix-shaped detector unit 109. This is shown as an example for the 89^{th} row of the detector unit 109. A corresponding diagram in which the signal intensity 204 is plotted over the columns 205 is shown in the left part of FIG. 2. The intensity maximum for the 89^{th} row 201 lies in the pixel of the 19^{th} column 205. The pixel from the 89^{th} row 201 and the 19^{th} column 205 is therefore assigned to the first receiving area 203. This procedure is repeated for all rows 201 of the detector unit 109 and the thus ascertained pixels are combined to form the first receiving area 203. This can in particular be carried out in one calibration step.

The measurement of received secondary light on the detector unit 109 shown in FIG. 2 can, for example, be used to calibrate the detector unit in order to adapt the first receiving area 203.

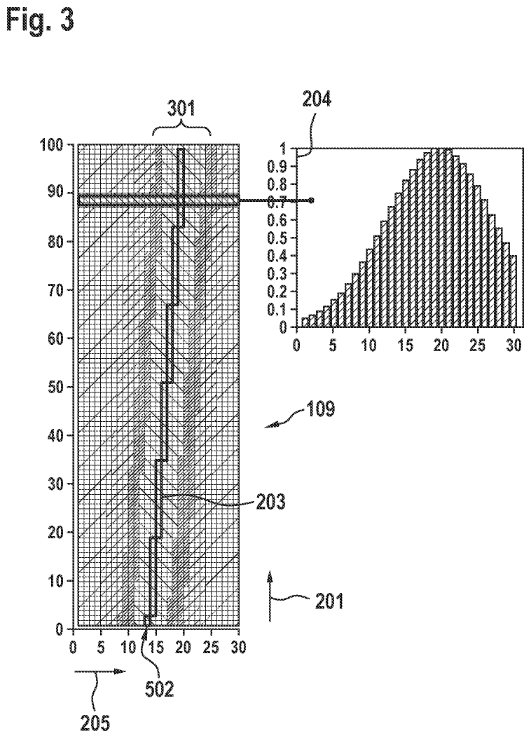

As an example, FIG. 3 shows an illustration of secondary light received on the detector unit 109 with defocusing of a LiDAR sensor 100, for instance of FIG. 1. FIG. 3 is similar to FIG. 2 in several respects, so that primarily the differences are discussed.

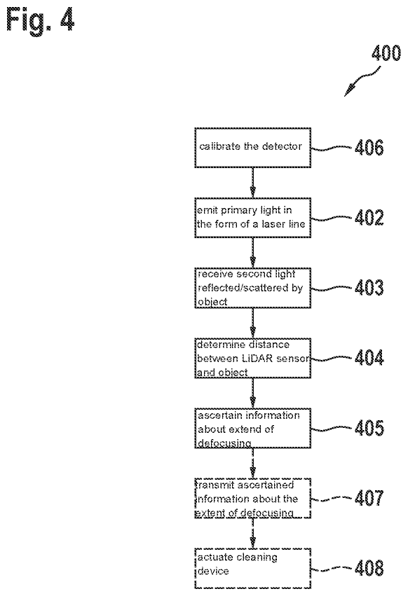

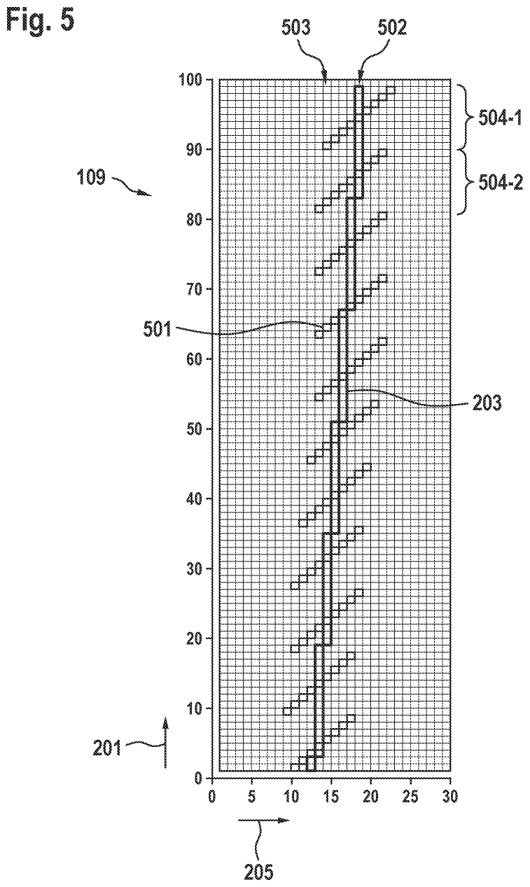

In FIG. 3, the pixels of the detector unit 109 on which secondary light is imaged are again lighter, which corresponds to a signal intensity in the respective pixel. The secondary light is again imaged on the detector unit 109 at a slight angle in the form of a line. However, due to the defocusing of the LiDAR sensor, for example caused by soiling on the protective glass and the resulting scattering, this line is significantly wider. In each row 201, the secondary light is imaged on pixels of approximately 14 columns. This is marked as an example for the 84^{th} to the 100^{th} row 201 with the bracket 301. A broadening of the signal intensity 204 can also be seen in the diagram shown on the right for the 89^{th} row of the detector unit 109. The point spread function shown here is significantly broadened compared to FIG. 2. The pixels that are not assigned to the first receiving area 203 can be used to form a second receiving area. This is explained in more detail in the description of the method 400 in FIG. 4 and for FIG. 5.

FIG. 4 shows an embodiment example of a method 400 for detecting soiling on a protective glass 103 of a LiDAR sensor 100, such as shown in FIG. 1 for example.

In Step 402, primary light 104 in the form of a laser line is emitted into a field of view of the LiDAR sensor 100 by means of at least one laser emitter unit 101 of a transmitting unit of the LiDAR sensor 100. In Step 403, secondary light 106 reflected and/or scattered in the field of view by an object 105 is received by means of a matrix-shaped detector unit 109 of a receiving unit. The detector unit 109 comprises a first 203 and a second 501 receiving area as described in FIGS. 2 and 5. In Step 404, a distance between the LiDAR sensor and an object in the field of view of the LiDAR sensor is determined on the basis of secondary light received in the first receiving area by means of an evaluation unit. In Step 405, information about an extent of defocusing of the LiDAR sensor is ascertained on the basis of secondary light 106 received in the second receiving area 501 by means of an evaluation unit. The first receiving area 203 and the second receiving area 501 are activated separately from one another to receive 403 secondary light. The second receiving area 501 is activated during individual scans of a plurality of consecutive scans.

The Step 406 of calibrating the detector unit 109 precedes the actual method 400, so to speak, and a result of the calibration is used to determine the first receiving area 203.

The method 400 can optionally include the further Step 407, in which ascertained information about an extent of defocusing of the LiDAR sensor 100 is transmitted to a control unit of a vehicle which is configured to control a driving function.

The method 400 can optionally include the further Step 408 in which a cleaning device of the LiDAR sensor 100 is actuated when the extent of defocusing exceeds a specified threshold value.

FIG. 5 shows an example illustration of the first receiving area 203 and the second receiving area 501 of the detector unit 109. The first receiving area 203 corresponds here to the first receiving area 203 described in FIG. 2. The second receiving area 501 of the detector unit 109 differs from the first receiving area 203. The second receiving area 501 is configured from a pattern 503 of pixels along the plurality of rows 201 of the matrix-shaped detector unit 109, wherein the pattern 503 comprises exactly one pixel in each row 201, and wherein the pattern 503 partially overlaps the first sequence 502, and wherein the number of pixels of the pattern 503 disposed outside the first receiving area 203 is greater than the number of pixels of the pattern 503 that overlap the first sequence 502.

In this example, the pattern 503 is configured such that it includes a plurality of sequences 504 of pixels. Each sequence 504 is configured such that it includes an odd number of pixels (nine in this example), wherein each pixel is disposed on the matrix-shaped detector unit 109 offset from an adjacent pixel by exactly one row 201 and one column 205. At least the pixel disposed in a center of the sequence 504 overlaps the first sequence 502. The first two sequences 504-1 and 504-2 of the pattern 503 are marked as an example.

The pattern 503 can also be referred to as the second sequence 503. The pixels of the second sequence 503 of FIG. 5 are outlined with a bolder printed line, just like the first sequence 502. The pixels of the pattern 503 of FIG. 5 are outlined with a bolder printed line, just like the first sequence 502.

The pattern 503 shown here is a possible example of the configuration of the first receiving area 501. Other patterns are possible as well.

What is claimed is:

1. A method for detecting defocusing of a LiDAR sensor, comprising the following steps:
emitting primary light in the form of a laser line into a field of view of the LiDAR sensor using at least one laser emitter unit of a transmitting unit of the LiDAR sensor to scan the field of view;
receiving secondary light reflected and/or scattered in the field of view by an object using a matrix-shaped detector unit of a receiving unit, wherein the matrix-shaped detector unit includes a first receiving area and a second receiving area which differs from the first receiving area;
determining a distance between the LiDAR sensor and an object in the field of view of the LiDAR sensor based on secondary light received in the first receiving area using an evaluation unit; and
ascertaining information about an extent of defocusing based on secondary light received in the second receiving area using an evaluation unit;
wherein:
the first receiving area is determined by calibrating the matrix-shaped detector unit,
the first receiving area and the second receiving area are activated separately from one another to receive the secondary light,
the second receiving area is activated during individual scans of a plurality of consecutive scans,
the first receiving area is configured from a first sequence (of pixels along a plurality of rows of the matrix-shaped detector unit, wherein the first sequence includes exactly one pixel in each row, and
the second receiving area is configured from a pattern of pixels along the plurality of rows of the matrix-shaped detector unit, wherein the pattern includes exactly one pixel in each row, and wherein the pattern partially overlaps the first sequence, and a number of pixels of the pattern disposed outside the first receiving area is greater than a number of pixels of the pattern that overlap the first sequence.

2. The method according to claim 1, wherein the first sequence is further configured such that: (i) a pixel of a row lies in a same column as a pixel of a directly adjacent row of the matrix-shaped detector unit and/or (ii) a pixel of a row lies in a directly adjacent column as a a pixel of a directly adjacent row of the matrix-shaped detector unit.

3. The method according to claim 1, further comprising:
transmitting the ascertained information about an extent of defocusing to a control unit of a vehicle, the control unit being configured to control a driving function of the vehicle.

4. The method according to claim 1, further comprising:
actuating a cleaning device of the LiDAR sensor based on the extent of defocusing exceeding a specified threshold value.

5. A non-transitory machine-readable storage medium on which is stored a computer program for detecting defocusing of a LiDAR sensor, the computer program, when executed by a computer, causing the computer to perform the following steps:
emitting primary light in the form of a laser line into a field of view of the LiDAR sensor using at least one laser emitter unit of a transmitting unit of the LiDAR sensor to scan the field of view;
receiving secondary light reflected and/or scattered in the field of view by an object using a matrix-shaped detector unit of a receiving unit, wherein the matrix-shaped detector unit includes a first receiving area and a second receiving area which differs from the first receiving area;
determining a distance between the LiDAR sensor and an object in the field of view of the LiDAR sensor based on secondary light received in the first receiving area using an evaluation unit; and
ascertaining information about an extent of defocusing based on secondary light received in the second receiving area using an evaluation unit;
wherein:
the first receiving area is determined by calibrating the matrix-shaped detector unit,
the first receiving area and the second receiving area are activated separately from one another to receive the secondary light,
the second receiving area is activated during individual scans of a plurality of consecutive scans,
the first receiving area is configured from a first sequence (of pixels along a plurality of rows of the matrix-shaped detector unit, wherein the first sequence includes exactly one pixel in each row, and
the second receiving area is configured from a pattern of pixels along the plurality of rows of the matrix-shaped detector unit, wherein the pattern includes exactly one pixel in each row, and wherein the pattern partially overlaps the first sequence, and a number of pixels of the pattern disposed outside the first receiving area is greater than a number of pixels of the pattern that overlap the first sequence.

6. A LiDAR sensor, comprising:
a transmitting unit including at least one laser emitter unit which is configured to emit primary light in the form of a laser line into a field of view of the LiDAR sensor;
a receiving unit including a matrix-shaped detector unit which is configured to receive secondary light reflected and/or scattered in the field of view by an object, wherein the matrix-shaped detector unit includes a first receiving area and a second receiving area which differs from the first receiving area; and
an evaluation unit configured to determine a distance between the LiDAR sensor and an object in the field of view of the LiDAR sensor based on secondary light received in the first receiving area and to ascertain information about an extent of defocusing based on secondary light received in the second receiving area;
wherein:
the first receiving area is determined by calibrating the matrix-shaped detector unit,
the first receiving area and the second receiving area can be activated separately from one another to receive secondary light,
the second receiving area can be activated during individual scans of a plurality of consecutive scans,
the first receiving area is configured from a first sequence of pixels along a plurality of rows of the matrix-shaped detector unit, wherein the first sequence includes exactly one pixel in each row,
the second receiving area is configured from a pattern of pixels along the plurality of rows of the matrix-shaped detector unit, wherein the pattern includes exactly one pixel in each row, and wherein the pattern partially overlaps the first sequence, and wherein a number of pixels of the pattern disposed outside the first receiving area is greater than the number of pixels of the pattern that overlap the first sequence.

7. The LiDAR sensor according to claim 6, further comprising a cleaning device configured to prevent, and/or inhibit, and/or remove at least one fleck of dirt on the protective glass.
